(19) United States
(12) Patent Application Publication
(10) Pub. No.: US 2012/0116755 A1
(43) Pub. Date: May 10, 2012

(54) APPARATUS FOR ENHANCING INTELLIGIBILITY OF SPEECH AND VOICE OUTPUT APPARATUS USING THE SAME

(75) Inventor: Sung Jin Park, Seongnam (KR)

(73) Assignee: THE VINE Corporation, Anyang-si (KR)

(21) Appl. No.: 13/378,002

(22) PCT Filed: Jun. 23, 2010
(86) PCT No.: PCT/KR2010/004078

§ 371 Date: Dec. 13, 2011

(30) Foreign Application Priority Data
Jun. 23, 2009 (KR) 10-2009-0055845
Jun. 22, 2010 (KR) 10-2009-0059196

(51) Int. Cl. G10L 15/20

(52) U.S. Cl. 704/205; 704/E15.039

(57) ABSTRACT

An apparatus for enhancing intelligibility of speech and a voice output apparatus using the same are provided. The apparatus detects a level of a voice frame of an input signal through an input envelope detection unit, provides the level to a cutoff frequency estimation unit, detects a level of a voice frame of an output signal through an output envelope detection unit, provides the level to the cutoff frequency estimation unit, determines a difference value between a level of an N-th voice frame that is received from the input envelope detection unit and a level of an (N−1)st voice frame that is received from the output envelope detection unit in the cutoff frequency estimation unit, calculates a cutoff frequency for amplifying a consonant component of the input signal with the difference value, and a shelving filter filters the input signal according to a cutoff frequency that is calculated by the cutoff frequency estimation unit and selectively amplifies a portion that is estimated as a consonant component of the input signal. Accordingly, the shelving filter dynamically changes a cutoff frequency according to more or less of a consonant component in the input signal and according to less being changed, amplifies a high frequency component corresponding to a consonant component of the input signal and attenuates a low frequency component and thus the consonant component is selectively emphasized, whereby speech intelligibility is enhanced.

### BACKGROUND OF THE INVENTION

(a) Field of the Invention

The present invention relates to a method and apparatus for enhancing a sound quality of a voice signal in a digital communication field. More specifically, the present invention relates to an apparatus for enhancing intelligibility of a received voice signal and a voice output apparatus using the same.

(b) Description of the Related Art

As digital music technology is widely used, consumer's expectation for a good voice call quality also rises. However, due to the fact that voice output apparatus is designed in a small and slim device, sound quality of a voice call is even poor than the previous handset's voice quality.

Particularly, the related arts for improving a receiving voice quality of a mobile phone in a noise environment are noise canceller, an equalizer and automatic adjustment of receiving sound volume; noise cancelling technology causes metallic noise according to distortion of a voice signal, the equalizer is minute in improvement of sonic quality, and amplification of a received sound quality causes serious distortion when a sound volume of a speaker exceeds a maximum sound volume due to a problem according to a thin size of a mobile phone.

Here, the equalizer technology amplifies an entire signal up to 3-10 dB in order to increase intelligibility of speech when a listener is in a heavy noise area.

However, it causes instability and listening fatigue of a listener to raise electric power in order to obtain a larger signal to noise ratio (SNR), and in most small terminals, because a sound level immediate before saturation is set to a maximum sound volume, additional amplification causes distorted sound.

Actually, under the ambient noise, if a larger SNR is secured, a listener can hear well voice of another party. This implies, when a sound volume is raised, a listener can hear well.

However, when an amplification level overpasses a predetermined level, sound output from a voice output apparatus becomes saturated or causes a distortion phenomenon, and in a small voice output apparatus, a sound-saturation phenomenon and a distortion phenomenon become more serious.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for enhancing intelligibility of speech for having advantages of improving a received sound quality by enhancing only speech intelligibility instead of an entire output of a received voice signal.

The present invention further provides a voice output apparatus having advantages of manually or automatically adjusting a received sound volume according to whether a communication environment is a noise environment and enhancing speech intelligibility.

The present invention further provides a voice output apparatus having advantages of enabling a user to determine an output state according to enhancement of speech intelligibility with the naked eye.

An exemplary embodiment of the present invention provides an apparatus for enhancing intelligibility of speech, the apparatus including: an input envelope detection unit that detects a level of a voice frame of an input signal; an output envelope detection unit that detects a level of a voice frame of an output signal; a cutoff frequency estimation unit that determines a difference value between a level of an N-th voice frame that is received from the input envelope detection unit and a level of an (N−1)st voice frame that is received from the output envelope detection unit and that calculates a cutoff frequency for amplifying a consonant component of the input signal with the difference value; a shelving filter that filters the input signal according to the cutoff frequency that is calculated by the cutoff frequency estimation unit and that filters to selectively amplify a portion that is estimated as a consonant component of the input signal; and a voice detector that determines whether the input signal is a voice signal or a non-voice signal by analyzing the input signal and that bypasses, if the input signal is a non-voice signal, the input signal to the output signal and that provides, if the input signal is a voice signal, the input signal as an input of the input envelope detection unit and the shelving filter.

The cutoff frequency estimation unit may lower a cutoff frequency that is set to the shelving filter by a setting value, if a level of the N-th voice frame is higher than that of the (N−1)st voice frame or raise a cutoff frequency that is set to the shelving filter by a setting value, if a level of the N-th voice frame is lower than that of the (N−1)st voice frame.

Another embodiment of the present invention provides a voice output apparatus using an apparatus for enhancing intelligibility of speech including: a microphone that inputs and amplifies a first voice signal from the outside; a noise environment determining unit that measures intensity of the first voice signal and that determines whether a peripheral environment is noise environment based on signal intensity of the first voice signal; a voice processor that changes and outputs the input voice signal to a defined form of second voice signal; a sound volume adjusting unit that adjusts a sound output level to a setting level when the noise environment determining unit determines that a peripheral environment is noise environment and that amplifies and outputs the second voice signal to the adjusted setting level; an intelligibility enhancing unit that enhances intelligibility of a third voice signal that is input through the sound volume adjusting unit and that outputs the third voice signal to a fourth voice signal; a sound output unit that outputs a voice signal that is output from the fourth voice signal and the sound volume adjusting unit to the outside; and an output display unit that outputs an intelligibility display representing that the fourth voice signal that is output by the sound output unit by interlocking with an intelligibility enhancing operation of the intelligibility enhancing unit is a voice signal in which intelligibility is enhanced.

The intelligibility enhancing unit is an apparatus for enhancing intelligibility of speech according to an exemplary embodiment of the present invention.

The setting level may be a level higher by one level than the present set sound output level or one of highest sound output levels.

The sound volume adjusting unit may adjust and output the second voice signal to the specific sound output level when setting to a specific sound output level is input by a user.

The intelligibility display may be a display different from a first display representing a sound output level and may be displayed on a screen together with the first display or may be a voice or sound output notifying that a voice having enhanced intelligibility is output.

According to an exemplary embodiment of the present invention, a voice output apparatus automatically determines a communication environment of a user, adjusts a received sound volume and enhances speech intelligibility to correspond to a communication environment and thus the user can perform communication in a state in which a received sound quality is enhanced.

Further, according to an exemplary embodiment of the present invention, when a user requests enhancement of a sound quality while performing communication, a voice output apparatus performs operation of enhancing speech intelligibility to correspond to a request for enhancement of a sound quality of the user and thus the user can hear sound in which a received sound quality is enhanced to correspond to a user request.

Further, according to an exemplary embodiment of the present invention, by displaying a state in which a received sound quality is improved and output on a screen of a voice output apparatus, a user can know that present output sound is sound in which a received sound quality is improved.

### BRIEF DESCRIPTION OF THE DRAWINGS

FIG. 1 is a block diagram illustrating a configuration of an apparatus for enhancing intelligibility of speech according to an exemplary embodiment of the present invention.

FIG. 2 is a graph illustrating frequency characteristics of a general shelving filter.

FIG. 3 is a diagram illustrating an example of results when performing a signal processing in a state where an apparatus for enhancing intelligibility of speech according to an exemplary embodiment of the present invention is mounted in a mobile phone terminal.

FIG. 4 is a diagram illustrating another example of a result in which a consonant is selectively filtered by an apparatus for enhancing intelligibility of speech according to an exemplary embodiment of the present invention.

FIG. 5 is a block diagram illustrating a configuration of a voice output apparatus according to an exemplary embodiment of the present invention.

FIG. 6 is a flowchart illustrating a method of processing received sound in a voice output apparatus according to a first exemplary embodiment of the present invention.

FIG. 7 is a flowchart illustrating a method of processing received sound in a voice output apparatus according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

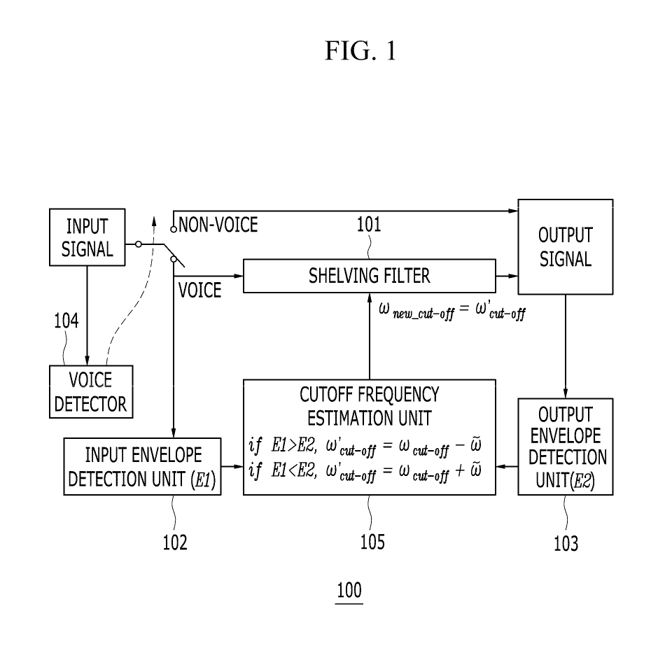

Hereinafter, an apparatus for enhancing intelligibility of speech according to an exemplary embodiment of the present invention will be described with reference to FIG. 1.

Before description, in a voice signal, a consonant portion has a relatively very small signal component, compared with a vowel. However, in a process of processing an audio signal of a network equipment and a terminal of a mobile communication device, the small signal component often disappears or decreases. Therefore, when communication is performed using the mobile phone, a user may feel dull sound or may not know who is another party with voice.

An apparatus for enhancing intelligibility of speech according to an exemplary embodiment of the present invention enables a signal component of a consonant portion not to disappear or decrease in a process of processing an audio signal. That is, an apparatus for enhancing intelligibility of speech according to an exemplary embodiment of the present invention selectively emphasizes a signal component of a consonant portion and enhances speech intelligibility.

FIG. 1 is a block diagram illustrating a configuration of an apparatus for enhancing intelligibility of speech 100 according to an exemplary embodiment of the present invention. As shown in FIG. 1, the apparatus for enhancing intelligibility of speech 100 according to an exemplary embodiment of the present invention includes a shelving filter 101, an input envelope detection unit 102, an output envelope detection unit 103, a voice detector 104, and a cutoff frequency estimation unit 105.

The input envelope detection unit 102 detects an amplitude level (hereinafter, referred to as a ‘present input voice signal level’) of an envelope of a presently input voice signal in a voice frame unit and provides the detected amplitude level to the cutoff frequency estimation unit 105.

The output envelope detection unit 103 calculates an amplitude level of an envelope in a voice frame unit of an output voice signal and provides an envelope amplitude level of an immediately preceding voice frame (hereinafter, referred to as a ‘previous output voice signal level’) of a presently output voice frame to the cutoff frequency estimation unit 105.

The voice detector 104 analyzes a frequency band of a received input signal and determines whether the input signal is a voice signal that is generated by a person. The voice detector 104 is generally referred to as a voice activity detector (VAD) and enables to by-pass output the input signal as an output voice without passing through the shelving filter 101 when an input signal is not a voice signal. The voice detector 104 emphasizes a voice signal of a specific portion by passing through the preset shelving filter 101 when an input signal is a voice signal.

The cutoff frequency estimation unit 105 receives a present input voice signal level from the input envelope detection unit 102 and receives a previous output voice signal from the output envelope detection unit 103. The cutoff frequency estimation unit 105 compares a present input voice signal level and a previous output voice signal, compares a difference size between two amplitude levels, and calculates a cutoff frequency that can dynamically change characteristics of the shelving filter 101.

The cutoff frequency estimation unit 105 enables a cutoff frequency that is calculated according to a difference size between two amplitude levels to be a cutoff frequency of the shelving filter 101. That is, the cutoff frequency estimation unit 105 changes ω_{cut-off} of Equation 4 in order to enable a cutoff frequency that is calculated according to a difference size between two amplitude levels to be a cutoff frequency of the shelving filter 101.

If a difference size between two amplitude levels is a positive number (i.e., if a present input voice signal level is larger than a previous output voice signal level), the cutoff frequency estimation unit 105 lowers a cutoff frequency by a setting value ω̅. If a difference size between two amplitude levels is a negative number, the cutoff frequency estimation unit 105 raises a cutoff frequency that is presently set to the shelving filter 101 by a setting value ω̅. In this case, a changed value i.e., a setting value ω̅ is an experimentally preset value.

The shelving filter 101 receives a cutoff frequency that is calculated by the cutoff frequency estimation unit 105, performs high frequency passage filtering of an input voice signal according to the received cutoff frequency, and outputs an output voice signal.

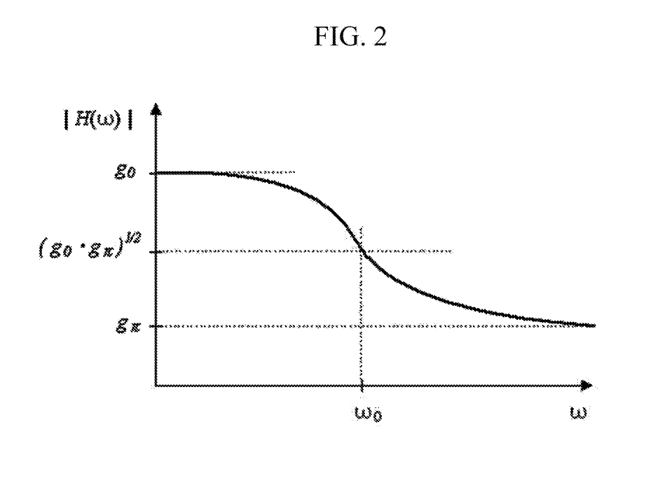

The shelving filter 101 mainly uses a shelving filter that has been much used for an audio design, and a transfer function H(s) of a general shelving filter is represented by Equation 1, and frequency characteristics are shown in FIG. 2.

$$H ( s ) = \frac{{g}_{Π} \cdot s + {g}_{0} \cdot ρ}{s + ρ} \qquad ( Equation 1 )$$

where ρ is a coefficient that adjusts a transition frequency, and g₀ and g_{Π} are zero and a gain value of a high frequency, respectively and are constants that are obtained by calculating an envelope of each frame. Here, when |H(j·1)|²=g₀·g_{Π}, is again arranged with ρ, Equation 1 is represented by Equation 2.

$$ρ = {( \frac{{g}_{Π}}{{g}_{0}} )}^{\frac{1}{2}} \qquad ( Equation 2 )$$

When Equation 2 is substituted to Equation 1, an analog transfer function of Equation 3 is obtained.

$$H ( s ) = \frac{{g}_{Π} s + {( {g}_{0} \cdot {g}_{Π} )}^{\frac{1}{2}}}{s + {( {g}_{Π} / {g}_{0} )}^{\frac{1}{2}}} \qquad ( Equation 3 )$$

When Equation 3 is converted to response characteristics of a digital domain by bi-linear transform, Equation 4 is obtained. Here, bi-linear transform is defined as

$$\begin{matrix}h ( z ) = h ( s ( z ) ) , s = \frac{2}{T} \cdot \frac{1 - {z}^{- 1}}{1 + {z}^{- 1}} . & \\ H ( z ) = \frac{{g}_{Π}}{2} ( 1 + \frac{( T - 2 ) + ( T + 2 ) {z}^{- 1}}{( T + 2 ) + ( T - 2 ) {z}^{- 1}} ) + \frac{{g}_{0}}{2} ( 1 - \frac{( T - 2 ) + ( T + 2 ) {z}^{- 1}}{( T + 2 ) + ( T - 2 ) {z}^{- 1}} ) & ( Equation 4 )\end{matrix}$$

In Equation 4, T=2\sqrt{g_{Π}/g₀} tan(ω_{cut-off}/2) value is a value that determines characteristics of a high frequency passage filter.

The shelving filter 101 has frequency characteristics of a general shelving filter by such a transfer function, as in the graph that is shown in FIG. 2. Because a frequency characteristic graph of a general shelving filter is disclosed in several documents, a detailed description thereof will be omitted.

An apparatus for enhancing intelligibility of speech according to an exemplary embodiment of the present invention having the above-described configuration enhances speech intelligibility by selectively emphasizing a portion that is estimated as a consonant component of an input voice signal. Hereinafter, operation of an apparatus for enhancing intelligibility of speech according to an exemplary embodiment of the present invention will be described.

When an input signal is received, the voice detector 104 determines whether an input signal is a voice signal or a non-voice signal. If an input signal is a voice signal, the voice detector 104 provides the input signal to the shelving filter 101. In this case, the input signal that is input to the shelving filter 101 is also input to the input envelope detection unit 102, and the input envelope detection unit 102 detects an envelope level of the input signal and provides the envelope level to the cutoff frequency estimation unit 105.

The input signal that is input to the shelving filter 101 is processed according to a filter transfer function that is set to the shelving filter 101 and is output as an output signal. In this case, an output signal that is output from the shelving filter 101 is output to the outside and is simultaneously input to the output envelope detection unit 103. Thereafter, the output envelope detection unit 103 detects an envelope level of the input output signal and provides the envelope level to the cutoff frequency estimation unit 105.

Here, the cutoff frequency estimation unit 105 inputs an envelope level of an input signal and an envelope level of an output signal, but uses an input signal of a present voice frame and an output signal of a previous voice frame without using an input signal and an output signal of the same voice frame.

That is, the cutoff frequency estimation unit 105 calculates an envelope level difference E1-E2 between an envelope level of an output signal of a previous frame (i.e., a previous output voice signal level) E2 and an envelope level of an input signal of a present frame (i.e., a present input voice signal level) E1.

If a size of a difference E1-E2 between a present input voice signal level and a previous output voice signal level is a positive number, the cutoff frequency estimation unit 105 determines that a present input voice signal level is higher than a previous output voice signal level, and if a size of a difference E1-E2 between a present input voice signal level and a previous output voice signal level is a negative number, the cutoff frequency estimation unit 105 determines that a present input voice signal level is lower than a previous output voice signal level.

If a difference between the two levels is a positive number, the cutoff frequency estimation unit 105 lowers a cutoff frequency that is presently set to the shelving filter 101 by a setting value [symbol] . If a difference between the two levels is a negative number, the cutoff frequency estimation unit 105 raises a cutoff frequency that is presently set to the shelving filter 101 by a setting value [symbol] .

When a value of an envelope decreases, the cutoff frequency estimation unit 105 regards that many consonant components exist in a voice signal and emphasizes a specific high frequency component. Here, a high frequency component is in a range of about 1.5 KHz to 2.5 KHz.

In this case, a low level of a determined cutoff frequency changes a cutoff frequency by an experimentally preset value, i.e., a setting value [symbol] according to a difference between a present voice input signal level and a previous voice output signal level.

In this way, by dynamically changing a cutoff frequency, a consonant component high frequency component of an output voice signal that is output from the shelving filter 101 is amplified, but a low frequency component is attenuated. Therefore, an average root-mean-square (RMS) energy degree is sustained without changing even after filtering.

In this case, because a consonant includes a major high frequency component, compared with a vowel, when an output voice signal is a consonant, power of a pronunciation increases, and thus speech intelligibility of a received voice signal is improved.

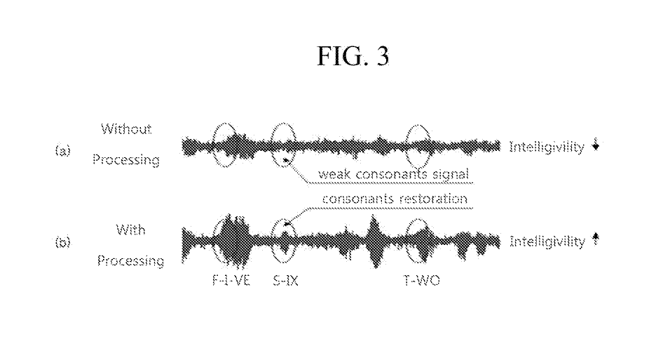

An example representing that intelligibility of speech is enhanced by an apparatus for enhancing intelligibility of speech according to an exemplary embodiment of the present invention is described with reference to FIG. 3. FIG. 3 illustrates an example of a result in which an apparatus for enhancing intelligibility of speech according to an exemplary embodiment of the present invention is mounted in a mobile terminal and in which a signal is processed and represents a case of receiving a voice signal of “five”, “six”, and “two”.

FIG. 3A is a frequency waveform diagram of an output voice signal that is output in a state in which a signal processing is not performed according to the present invention, and FIG. 3B is a frequency waveform diagram of an output voice signal that is output in a state in which a signal processing is performed according to the present invention.

As shown in FIG. 3A, when a voice signal of five, six and two is received, a consonant signal component corresponding to “F”, “S”, and “W” that are conventionally marked with a circle is not amplified.

Alternatively, as shown in FIG. 3B, the apparatus for enhancing intelligibility of speech 100 according to an exemplary embodiment of the present invention selectively amplifies and outputs a consonant signal component corresponding to “F”, “S”, and “W” that are marked with a circle, when a voice signal of “five”, “six”, and “two” is received. It can be seen that the apparatus for enhancing intelligibility of speech 100 according to the exemplary embodiment of the present invention selectively amplifies and outputs a consonant signal component corresponding to “V”, “X”, and “T”.

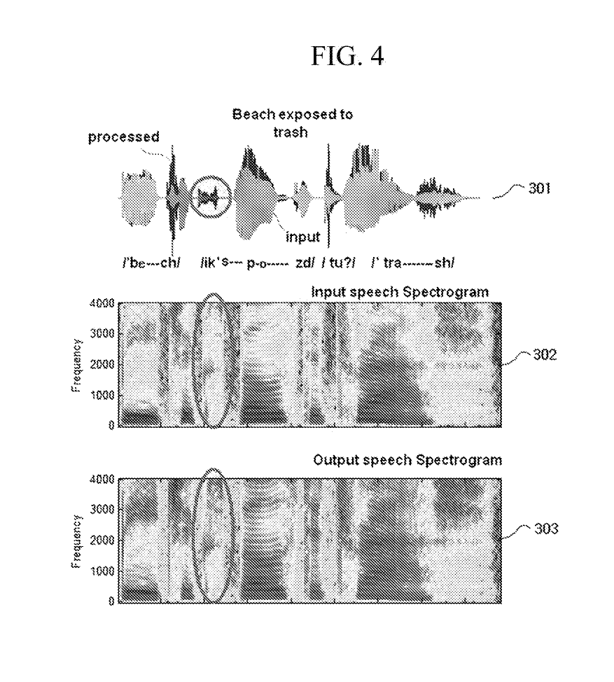

FIG. 4 illustrates another example in which speech intelligibility is improved by an apparatus for enhancing intelligibility of speech according to an exemplary embodiment of the present invention. FIG. 4 is a diagram illustrating another example of a result in which a consonant is selectively filtered by an apparatus for enhancing intelligibility of speech according to an exemplary embodiment of the present invention.

FIG. 4A is a frequency waveform diagram illustrating a voice signal that is input and output by an apparatus for enhancing intelligibility of speech according to an exemplary embodiment of the present invention, and an ‘input’ is a waveform diagram representing a gray color and is a waveform of a received voice signal, and a ‘processed’ is a waveform diagram representing a black color and is a waveform of a voice signal that is amplified by filtering.

FIG. 4B is a spectrogram of an input voice signal, and FIG. 4C is a spectrogram of an output voice signal.

As can be seen through an input voice signal and an output voice signal that are shown in FIG. 4A, when a voice signal of “beach exposed to trash” is received, the apparatus for enhancing intelligibility of speech 100 relatively emphasizes (i.e., amplifies) and outputs a signal component of “b”, “ch”, “k”, “p”, “zd”, “t”, and “sh”, which are a consonant, compared with a vowel while changing a cutoff frequency of the shelving filter 101, which is a high frequency passage filter.

As can be seen in a spectrogram that is shown in FIGS. 4B and 4C, a consonant portion that is marked by a circle has a high distribution in a high frequency component in an output voice signal rather than an input voice signal.

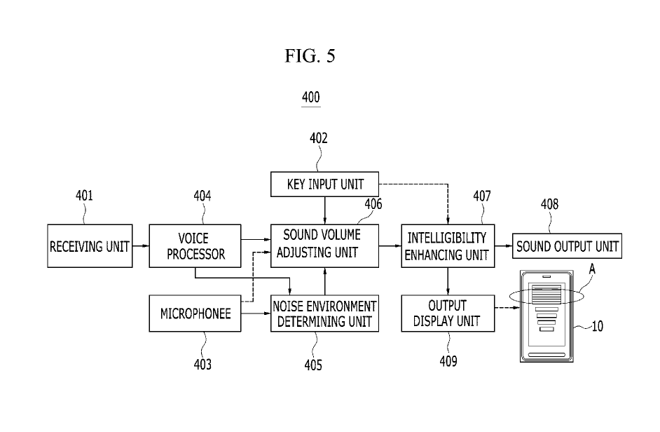

Hereinafter, a voice output apparatus according to an exemplary embodiment of the present invention will be described with reference to FIG. 5. FIG. 5 is a block diagram illustrating a configuration of a voice output apparatus according to an exemplary embodiment of the present invention.

A voice output apparatus 400 according to an exemplary embodiment of the present invention is an apparatus that receives and outputs a voice signal and may be a mobile phone, a general phone, a portable multimedia player (PMP), a digital multimedia broadcasting (DMB) receiver, an MP3 player, a hands-free kit for vehicles, a Bluetooth ear-set, etc.

Hereinafter, a case where the voice output apparatus 400 is a mobile phone is exemplified.

As shown in FIG. 5, the voice output apparatus 400 according to an exemplary embodiment of the present invention includes a receiving unit 401, a key input unit 402, a microphone 403, a voice processor 404, a noise environment determining unit 405, a sound volume adjusting unit 406, an intelligibility enhancing unit 407, a sound output unit 408, and an output display unit 409.

The receiving unit 401 receives a voice signal that is transmitted from the outside. For example, the receiving unit 401 is an antenna, etc.

The key input unit 402 includes a plurality of button keys or a touch pad and is used for inputting a manipulation of a user. The microphone 403 inputs and amplifies a user's voice or peripheral noise.

The voice processor 404 decodes a voice signal that is received in the receiving unit 401 and outputs the voice signal to an analog signal. For example, the voice processor 404 includes a decoder, and when a received voice signal is a digital signal, the voice processor 404 further includes a digital to analog (D/A) converter.

The noise environment determining unit 405 measures intensity of peripheral noise that is collected through the microphone 403, measures intensity of an analog voice signal that is received from the voice processor 404, and compares the measured two voice signals. In this case, intensity of peripheral noise is average intensity of intensity of each of peripheral noise.

If intensity of peripheral noise is larger than intensity of a voice signal, the noise environment determining unit 405 determines a peripheral environment as a noise environment.

As another example, when a peripheral environment is determined as a noise environment, the noise environment determining unit 405 may not use intensity of the received voice signal. In this case, the noise environment determining unit 405 uses setting reference intensity and determines a peripheral environment as a noise environment when intensity of peripheral noise is larger than setting reference intensity.

The sound volume adjusting unit 406 amplifies or reduces a voice signal that receives from the voice processor 404 or the microphone 403 to a preset output sound volume level and outputs the voice signal to the sound output unit 409, and at this case, adjustment of an output sound volume level that is set to the sound volume adjusting unit 406 is divided into a manual type (manual sound volume adjustment) and an automatic type (automatic sound volume adjustment).

A manual type is used when a user designates a specific sound volume output level by adjusting a sound volume adjustment button key in the key input unit 402, and the sound volume adjusting unit 406 adjusts an output sound volume level to a specific sound volume output level in which a user designates.

An automatic type is used when a peripheral noise level that is determined by the noise environment determining unit 405 is different from a preset sound volume output level. In this case, the sound volume adjusting unit 406 compares a peripheral noise level and a level of a received voice signal, and if a peripheral noise level is higher than a level of a received voice signal, the sound volume adjusting unit 406 adjusts the sound volume output level to be higher than the peripheral noise level. The sound volume adjusting unit 406 compares a peripheral noise level with a preset sound volume output level and adjusts the sound volume output level.

The intelligibility enhancing unit 407 is an apparatus for enhancing intelligibility of speech 100 according to the exemplary embodiment of the present invention that is described with reference to FIG. 1. The intelligibility enhancing unit 407 enhances and outputs intelligibility of a voice signal that is input from the sound volume adjusting unit 406, and a sound volume output level that is adjusted by the sound volume adjusting unit 406 is applied to a voice signal that is output at this time.

A voice signal that is input to the intelligibility enhancing unit 407 is an analog voice signal that is input through the receiving unit 401 or an analog voice signal that is input through the microphone 403.

An intelligibility enhancing operation of the intelligibility enhancing unit 407 is performed when a peripheral environment is a noise environment, when a button key that instructs intelligibility enhancement is input, or when the voice output apparatus 400 operates in an intelligibility enhancing mode.

Here, in a case where the voice output apparatus 400 operates in an intelligibility enhancing mode, the intelligibility enhancing unit 407 unconditionally performs an intelligibility enhancing operation when a voice signal that is input to the microphone 403 is output to the sound output unit 408 or when a voice signal is received to the receiving unit 401 and is output to the sound output unit 408.

The intelligibility enhancing unit 407 operates only when a sound volume output level that is output to the sound output unit 409 is the maximum, and even if a sound volume output level is not the maximum, when a peripheral environment is a noise environment, the intelligibility enhancing unit 407 operates, and even if a peripheral environment is not a noise environment, when a user request exists, the intelligibility enhancing unit 407 operates.

The sound output unit 408 includes a speaker and outputs an analog voice signal that is output from the sound volume adjusting unit 406 through a speaker. In this case, intelligibility of a voice signal that is output from the sound output unit 408 may be enhanced or may not be enhanced by the intelligibility enhancing unit 407.

The output display unit 409 displays an output level of a voice signal. The output display unit 409 displays a sound volume output level display corresponding to a sound volume output level that is adjusted by the sound volume adjusting unit 406 to the outside. Particularly, when the output voice signal is an output in which intelligibility is enhanced by the intelligibility enhancing unit 407, the output display unit 409 displays an intelligibility enhancement display together with a sound volume output level display to the outside.

For example, as shown in FIG. 5, when a sound volume output level display is displayed in a front display window 10 of the voice output apparatus 400, an intelligibility enhancement display is displayed separately from a sound volume output level display like A.

In this way, as an intelligibility enhancement display is displayed separately from a sound volume output level display, a user can see with the naked eye that an intelligibility enhancing operation is performed in the voice output apparatus 400 through the intelligibility enhancement display.

Another exemplary embodiment of the present invention further includes at least of a vibration unit (not shown) and an alarm unit (not shown) interlocking with an intelligibility enhancement display of the output display unit 409. The vibration unit vibrates the voice output apparatus 400 interlocking with an intelligibility enhancement display of the output display unit 409, and the alarm unit outputs intelligibility enhancing alarm sound notifying intelligibility enhancement interlocking with an intelligibility enhancement display of the output display unit 409.

When a voice output apparatus according to an exemplary embodiment of the present invention is a general phone, the receiving unit 401 is a form that is connected to a cable terminal, not an antenna form. When a voice output apparatus according to an exemplary embodiment of the present invention is a portable media player such as a PMP, a DMB receiver, and a MP3 player, the voice output apparatus may not have the receiving unit 401, and the voice processor 404 reproduces a stored multimedia file and provides an analog voice signal to the sound volume adjusting unit 406.

Further, when a voice output apparatus according to an exemplary embodiment of the present invention is a hands-free kit or a Bluetooth ear-set, the voice output apparatus does not require the receiving unit 401 and the voice processor 404.

Finally, the voice output apparatus according to an exemplary embodiment of the present invention basically includes the microphone 403, the noise environment determining unit 405, the voice processor 404, the sound volume adjusting unit 406, the intelligibility enhancing unit 407, the sound output unit 408, and the output display unit 409.

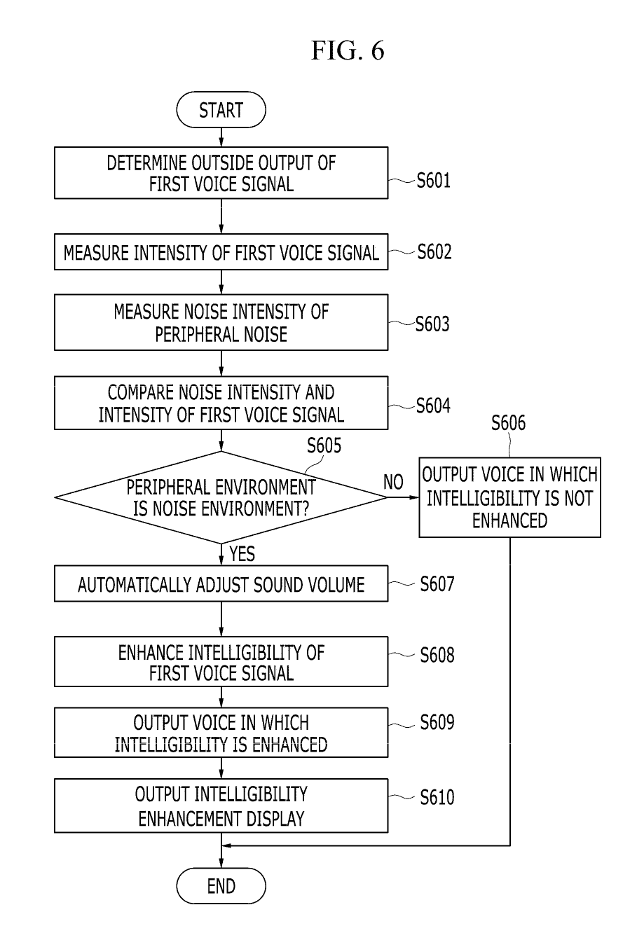

Hereinafter, an example of a method of processing received sound according to a first exemplary embodiment of the present invention will be described with reference to FIG. 6. FIG. 6 is a flowchart illustrating a method of processing received sound in a voice output apparatus according to a first exemplary embodiment of the present invention.

In a method of processing received sound according to a first exemplary embodiment of the present invention, when a peripheral environment is a noise environment, an operation of enhancing intelligibility of speech is always performed.

As shown in FIG. 6, the voice output apparatus 400 determines to output a first voice signal through the sound output unit 408 according to a first situation (S601).

In this case, a first condition indicates when outputting a voice signal (corresponding to a first voice signal) that is received through the receiving unit 401, when reproducing a voice file that is stored therein by a user's request, or when outputting a voice signal (corresponding to a first voice signal) that is input through the microphone 403 through the sound output unit 408 by a specific mode. When reproducing a voice file, an analog voice signal in which a signal of a voice file is processed corresponds to the first voice signal.

The noise environment determining unit 405 measures intensity of the first voice signal according to the first situation (S602) and measures intensity of peripheral noise that is received through the microphone 403 (S603). The noise environment determining unit 405 compares intensity of the measured first voice signal and intensity of peripheral noise (S604), and if intensity of peripheral noise is larger than that of the first voice signal, the noise environment determining unit 405 determines the peripheral environment as a noise environment, and if intensity of peripheral noise is equal to smaller than that of the first voice signal, the noise environment determining unit 405 determines that the peripheral environment is not a noise environment (S605).

If the peripheral environment is not a noise environment, the voice output apparatus 400 does not perform an operation of enhancing intelligibility of the first voice signal and outputs the first voice signal through the sound output unit 408 (S606).

If the peripheral environment is a noise environment, the noise environment determining unit 405 notifies the sound volume adjusting unit 406 that the peripheral environment is a noise environment, and the sound volume adjusting unit 406 sets a setting sound volume output level corresponding to a noise environment, amplifies the first voice signal that is received through the voice processor 404 to a setting sound volume output level, and provides the first voice signal to the intelligibility enhancing unit 407 (S607).

Here, a setting sound volume output level is a maximum sound volume output level or a sound volume output level closer to a maximum sound volume output level. If a present set sound volume output level of the sound volume adjusting unit 406 is a setting sound volume output level or more, the sound volume adjusting unit 406 enables the present set sound volume output level to be a maximum sound volume output level, or sustains the present set sound volume output level.

When the intelligibility enhancing unit 407 receives the first voice signal from the noise environment determining unit 405, the intelligibility enhancing unit 407 enhances intelligibility by selectively emphasizing a consonant component of the received first voice signal (S608), and the intelligibility enhancing unit 407 outputs the first voice signal in which speech intelligibility is enhanced to the outside through the sound output unit 408 (S609).

While outputting the first voice signal in which speech intelligibility is enhanced through the sound output unit 408, the output display unit 409 displays an intelligibility enhancement display notifying that intelligibility is enhanced together with a signal intensity display of the first voice signal that is output through the sound output unit 408 by interlocking with an intelligibility enhancing operation of the intelligibility enhancing unit 407 on a screen (S610).

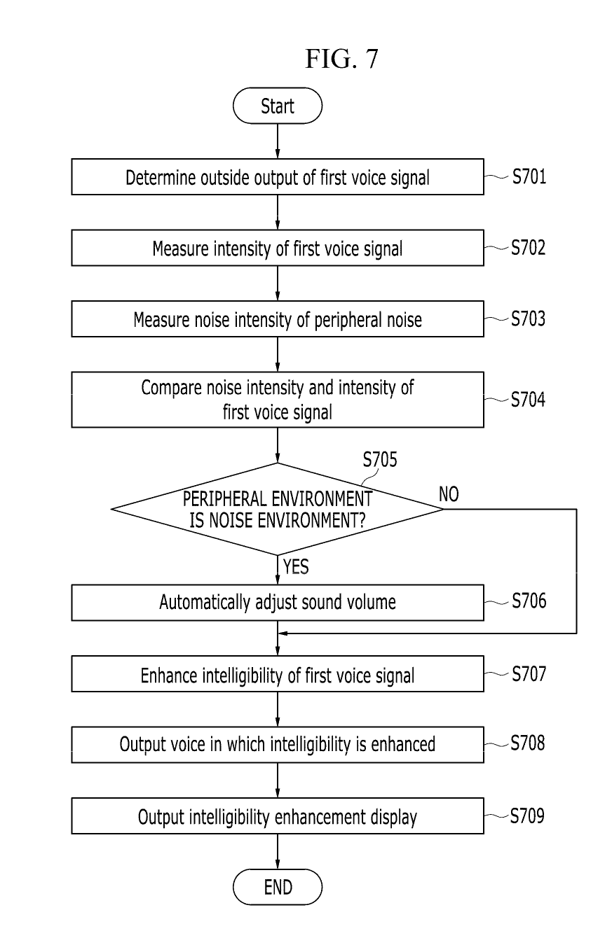

Hereinafter, a method of processing received sound according to a second exemplary embodiment of the present invention will be described with reference to FIG. 7. FIG. 7 is a flowchart illustrating a method of processing received sound in a voice output apparatus according to a second exemplary embodiment of the present invention.

A method of processing received sound in a voice output apparatus according to a second exemplary embodiment of the present invention is performed when a speech intelligibility enhancing operation is performed regardless of a noise environment.

As shown in FIG. 7, the voice output apparatus 400 determines to output a first voice signal through the sound output unit 408 according to a first situation (S701).

In this case, a first condition indicates when outputting a voice signal (corresponding to a first voice signal) that is received through the receiving unit 401, when reproducing a voice file that is stored therein by a user's request, or when outputting a voice signal (corresponding to a first voice signal) that is input through a microphone 403 through the sound output unit 408 by a specific mode. When reproducing a voice file, an analog voice signal in which a signal of a voice file is processed corresponds to the first voice signal.

The noise environment determining unit 405 measures intensity of the first voice signal according to the first situation (S702) and measures intensity of peripheral noise that is received through the microphone 403 (S703).

The noise environment determining unit 405 compares intensity of the first voice signal and intensity of peripheral noise (S704), and if intensity of peripheral noise is larger than that of the first voice signal, the noise environment determining unit 405 determines the peripheral environment as a noise environment, and if intensity of peripheral noise is equal to smaller than that of the first voice signal, the noise environment determining unit 405 determines that the peripheral environment is not a noise environment (S705).

If the peripheral environment is a noise environment, the noise environment determining unit 405 notifies the sound volume adjusting unit 406 that the peripheral environment is a noise environment, and the sound volume adjusting unit 406 sets a setting sound volume output level corresponding to a noise environment, amplifies the first voice signal that is received through the voice processor 404 to a setting sound volume output level, and provides the first voice signal to the intelligibility enhancing unit 407 (S706 and S707).

Here, a setting sound volume output level is a maximum sound volume output level or a sound volume output level closer to a maximum sound volume output level. If a present set sound volume output level of the sound volume adjusting unit 406 is a setting sound volume output level or more, the sound volume adjusting unit 406 enables the present set sound volume output level to be a maximum sound volume output level, or sustains the present set sound volume output level.

When the intelligibility enhancing unit 407 receives the first voice signal from the noise environment determining unit 405, the intelligibility enhancing unit 407 enhances intelligibility of speech by selectively emphasizing a consonant component of the received first voice signal (S707), and the intelligibility enhancing unit 407 outputs the first voice signal in which speech intelligibility is enhanced to the outside through the sound output unit 408 (S708).

While outputting the first voice signal in which speech intelligibility is enhanced through the sound output unit 408, the output display unit 409 displays an intelligibility enhancement display notifying that intelligibility of speech is enhanced together with a signal intensity display of the first voice signal that is output through the sound output unit 408 by interlocking with an intelligibility enhancing operation of the intelligibility enhancing unit 407 on a screen (S709).

If the peripheral environment is not a noise environment at step S705, steps S707, S708, and S709 are performed without performing step S706 of automatically adjusting a sound volume of the received first voice signal.

According to the foregoing exemplary embodiment of the present invention, when a peripheral environment is not a noise environment, operation of the sound output apparatus 400 is set not to perform automatic sound volume adjustment and intelligibility enhancement of a received voice signal. When the peripheral environment is not a noise environment, even if operation of the sound output apparatus 400 is set not to perform automatic sound volume adjustment and intelligibility enhancement of a received voice signal, when a user inputs a button key that instructs intelligibility enhancement, intelligibility of the received voice signal can be enhanced.

The above-described exemplary embodiment of the present invention may be not only embodied through an apparatus and a method but also embodied through a program that executes a function corresponding to a configuration of the exemplary embodiment of the present invention or through a recording medium on which the program is recorded and can be easily embodied by a person of ordinary skill in the art from a description of the foregoing exemplary embodiment.

According to an exemplary embodiment of the present invention, a voice output apparatus automatically determines a communication environment of a user, adjusts a received sound volume and enhances speech intelligibility to correspond to a communication environment and thus enables a user to perform communication in a state in which a received sound quality is enhanced, and enables the user to hear sound in which a sound quality is enhanced to correspond to a user request by performing operation of enhancing intelligibility of speech to correspond to a request for enhancement of a sound quality of the user, even if the user requests enhancement of a sound quality while performing communication. Further, according to an exemplary embodiment of the present invention, by displaying a state in which a received sound quality is enhanced and output on a screen of the voice output apparatus, a user can know that a present output sound is sound in which a received sound quality is improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for enhancing intelligibility of speech, the apparatus comprising:
an input envelope detection unit that detects a level of a voice frame of an input signal;
an output envelope detection unit that detects a level of a voice frame of an output signal;
a cutoff frequency estimation unit that determines a difference value between a level of an N-th voice frame that is received from the input envelope detection unit and a level of an (N−1)st voice frame that is received from the output envelope detection unit and that calculates a cutoff frequency for amplifying a consonant component of the input signal with the difference value;
a shelving filter that filters the input signal according to the cutoff frequency that is calculated by the cutoff frequency estimation unit and that filters to selectively amplify a portion that is estimated as a consonant component of the input signal; and
a voice detector that determines whether the input signal is a voice signal or a non-voice signal by analyzing the input signal and that bypasses, if the input signal is a non-voice signal, the input signal as the output signal and that provides, if the input signal is a voice signal, the input signal as an input of the input envelope detection unit and the shelving filter.

2. The apparatus of claim 1, wherein the cutoff frequency estimation unit lowers a cutoff frequency that is set to the shelving filter by a setting value, if a level of the N-th voice frame is higher than that of the (N−1)st voice frame.

3. The apparatus of claim 2, wherein the cutoff frequency estimation unit raises a cutoff frequency that is set to the shelving filter by a setting value, if a level of the N-th voice frame is lower than that of the (N−1)st voice frame.

4. A voice output apparatus using an apparatus for enhancing intelligibility of speech comprising:
a microphone that inputs and amplifies a first voice signal from the outside;
a noise environment determining unit that measures intensity of the first voice signal and that determines whether a peripheral environment is noise environment based on signal intensity of the first voice signal;
a voice processor that changes and outputs the input voice signal to a defined form of second voice signal;
a sound volume adjusting unit that adjusts a sound output level to a setting level when the noise environment determining unit determines that a peripheral environment is noise environment and that amplifies and outputs the second voice signal to the adjusted setting level;
an intelligibility enhancing unit that enhances intelligibility of a third voice signal that is input through the sound volume adjusting unit and that outputs the third voice signal to a fourth voice signal;
a sound output unit that outputs a voice signal that is output from the fourth voice signal and the sound volume adjusting unit to the outside; and
an output display unit that outputs an intelligibility display representing that the fourth voice signal that is output by the sound output unit by interlocking with an intelligibility enhancing operation of the intelligibility enhancing unit is a voice signal in which intelligibility is enhanced.

5. The voice output apparatus of claim 4, wherein the intelligibility enhancing unit comprises
an input envelope detection unit that detects a level of a voice frame of an input signal;
an output envelope detection unit that detects a level of a voice frame of an output signal;
a cutoff frequency estimation unit that determines a difference value between a level of an N-th voice frame that is received from the input envelope detection unit and a level of an (N−1)st voice frame that is received from the output envelope detection unit and that calculates a cutoff frequency for amplifying a consonant component of the input signal with the difference value;
a shelving filter that filters the input signal according to the cutoff frequency that is calculated by the cutoff frequency estimation unit and that filters to selectively amplify a portion that is estimated as a consonant component of the input signal; and
a voice detector that determines whether the input signal is a voice signal or a non-voice signal by analyzing the input signal and that bypasses, if the input signal is a non-voice signal, the input signal as the output signal and that provides, if the input signal is a voice signal, the input signal as an input of the input envelope detection unit and the shelving filter.

6. The voice output apparatus of claim 5, wherein the cutoff frequency estimation unit lowers a cutoff frequency that is set to the shelving filter by a setting value, if a level of the N-th voice frame is higher than that of the (N−1)st voice frame.

7. The voice output apparatus of claim 6, wherein the cutoff frequency estimation unit raises a cutoff frequency that is set to the shelving filter by a setting value, if a level of the N-th voice frame is lower than that of the (N−1)st voice frame.

8. The voice output apparatus of claim 7, wherein the setting level is higher by one level than the present set sound output level.

9. The voice output apparatus of claim 7, wherein the setting level is a highest sound output level.

10. The voice output apparatus of claim 8, wherein the sound volume adjusting unit adjusts and outputs the second voice signal to the specific sound output level when setting to a specific sound output level is input by a user.

11. The voice output apparatus of claim 10, wherein the intelligibility display is a display different from a first display representing a sound output level and is displayed on a screen together with the first display.

12. The voice output apparatus of claim 10, wherein the intelligibility display is a voice or sound output notifying that a voice having enhanced intelligibility is output.

13. The voice output apparatus of claim 10, wherein the intelligibility display is a display different from a first display representing a voice or sound output and a sound output level notifying that a voice having enhanced intelligibility is output and that is displayed on a screen.

14. The voice output apparatus of claim 9, wherein the sound volume adjusting unit adjusts and outputs the second voice signal to the specific sound output level when setting to a specific sound output level is input by a user.
